(19) United States
(12) Patent Application Publication
(10) Pub. No.: US 2005/0026107 A1
(43) Pub. Date: Feb. 3, 2005

(54) Therapeutic responsive dental gel composition

(75) Inventor: R. Eric Mongtomery, Lee, MA (US)

Correspondence Address: MAYER, BROWN, ROWE & MAW LLP, 190 SOUTH LASALLE ST, CHICAGO, IL, 60603-3441, US

(73) Assignee: BRITESMILE DEVELOPMENT, INC., Walnut Creek, CA (US)

(21) Appl. No.: 10/670,950

(22) Filed: Sep. 25, 2003

Related U.S. Application Data
(60) Provisional application No. 60/490,654, filed on Jul. 28, 2003.
(60) Provisional application No. 60/495,043, filed on Aug. 14, 2003.

(51) Int. Cl. A61C 5/04; A61C 5/00

(52) U.S. Cl. 433/89; 433/215

(57) ABSTRACT

A liquid oral therapeutic dental composition, that increases in viscosity upon contact with moisture following application to an oral cavity surface, is disclosed. The composition comprises a moisture responsive gel carrier comprising a moisture sensitive polymer complex and a water soluble salt and a therapeutic agent dispersed in the responsive gel carrier. Methods and devices for administering the composition are also disclosed.

### RELATED APPLICATIONS DATA

This application claims priority to U.S. Provisional No. 60/490,654, filed Jul. 28, 2003 and U.S. Provisional application No. 60/495,043, filed Aug. 14, 2003. All of the foregoing applications are hereby incorporated by reference to the extent permitted by law.

### FIELD OF THE INVENTION

The present invention relates to a therapeutic dental composition having responsive gelling properties, such that when placed in the oral cavity, the composition increases in viscosity and the therapeutic agent contained therein retains activity at the site of application. The present invention further relates to a method and device for delivering a therapeutic dental composition to the oral cavity of a subject.

### BACKGROUND OF INVENTION

For years, dental compositions such as tooth whiteners and fluoride gels have been applied to the teeth of patients in need of a cosmetic or therapeutic dental treatment. These compositions, usually in the form of a gel, paste or foam, have traditionally been comprised of one or more active therapeutic agents dissolved in an aqueous or water-soluble carrier. An aqueous or water-soluble carrier was used because the majority of dental therapeutic agents, such as inorganic fluorides (anticaries agents), peroxides (tooth whitening agents), chlorhexidine (an antibacterial agent), potassium nitrate (a tooth desensitizing agent) and polyphosphates (tartar control agents) are water-soluble compounds. Most of these compositions are intended to be brushed, rinsed or sprayed onto the teeth for a short period of time, for instance the few minutes during which the average individual will brush his or her teeth.

A number of dental treatments, though, require that a therapeutic agent be in contact for a much longer period of time than is practical by the above methods. Arch-shaped dental trays have been developed that are either customized by methods known in the art, or are in the one-size-fits-all category. Such trays are typically loaded with a small amount of a dental composition, placed over the teeth of the upper arch, the lower arch or both simultaneously (using two dental trays at the same time). While such devices and methods tend to greatly increase the length of time a dental composition remains in contact with the tooth surfaces, said compositions still remain highly soluble in water. Being soluble in water, these compositions rapidly dissolve and leach out of the dental tray once placed in the mouth in contact with saliva. Upon dilution, prior art compositions are seen to quickly migrate out of the dental tray and thus become free to contact areas of the oral cavity not intended for treatment. The diluted compositions may also be swallowed by the patient, for instance when a tooth whitening composition is loaded into a dental tray and placed in the oral cavity against the teeth for an extended period of time, such as overnight while the patient is asleep. The whitening composition within the tray gradually becomes lower in viscosity due to dilution with saliva, migrates out of the dental tray, and is unintentionally swallowed by the patient. Repeated ingestion of the oxidizing ingredients of such compositions may be detrimental to the tissue surfaces of the digestive tract.

Other delivery modes for applying tooth whitening compositions to the surfaces of the teeth have recently become available, each with different degrees of acceptance by the consumer and effectiveness. Crest® Whitestrips® (Procter & Gamble, Cincinnati, Ohio) are thin plastic strips that are coated on one side with a layer of tooth whitening gel and stored until use against a release backing (similar to a pressure sensitive label), in a unit dose laminated pouch. When a consumer or patient desires tooth whitening, the pouch is opened, the strip/gel combination is removed from the release backing, and the user carefully places the strip on the teeth to be whitened (gel side against the teeth). While this approach is safe and effective, the strips are somewhat cumbersome to handle and position, and there are instances where the entire plastic strip and associated gel have been swallowed by the consumer. The Crest® Whitestrips® gel is also water soluble, so salivary intrusion and gel dissolution occurs in a similar fashion to that observed with dental whitening trays.

Simply White (Colgate, Piscataway, N.J.) is a brush-on tooth whitening gel that is simply brushed onto the teeth using a nail polish type applicator bottle and brush combination. The brush handle tip is dipped into the bottle reservoir, picking up an amount of gel that is transferred to the teeth by dabbing or brushing the surfaces. The gel, which contains ethyl alcohol, is allowed to dry for 30 seconds before the user can close his or her mouth. This period of time is necessary for the gel to dry and become sufficiently thick so as not to immediately wash from the tooth surfaces due to salivary flow. Even so, the residence time of the Simply White gel is quite short, for example approximately 3 to 7 minutes. This period of time is insufficient for penetration of peroxide into the tooth to effectuate whitening, as is evidenced by the poor performance of this product. Clinical research has shown very limited efficacy, approximately 2-3 shades improvement, even over a 3 week period when applied twice a day. The clinical efficacy of the Simply White product does not compare well to Whitestrips® or regular tray-administered products, which in general are capable of whitening at a rate of approximately 4 to 7 shades in a 2-week period of use. As discussed above, however, these alternatives have the disadvantage in that they are cumbersome to use.

There is thus a need for improved compositions, methods and devices for administering a therapeutic agent to an oral cavity surface of a subject that overcome the limitations of the prior art described above. In particular, there is a need for therapeutic dental compositions, methods, and devices capable of treating an oral cavity surface quickly, easily and effectively without substantial loss of the therapeutic agent at the site of application and ingestion of the composition into the digestive tract. The compositions and methods of the present invention described herein satisfy these and other needs.

It is an object of this invention to provide an effective therapeutic dental composition that does not dilute upon application to an oral cavity surface and prevents leaching of the therapeutic agent into the digestive tract.

It is a further object of this invention to provide a therapeutic dental composition that is easy to use and that shortens the treatment time required to obtain a given level of therapeutic effect that is satisfactory to a subject.

It is yet another object of this invention to provide a device for conveniently administering a therapeutic dental composition to an oral cavity surface.

### SUMMARY OF INVENTION

The present invention relates to a novel therapeutic dental gel composition having responsive gelling properties, such that when placed in the oral cavity, the composition increases in viscosity and the therapeutic agent contained therein retains activity at the site of application for longer periods of time than prior art compositions and methods of applying them.

The present invention further relates to a therapeutic dental gel composition in a physical form that may be directly applied to an oral cavity surface, thus obviating the need for a dental tray or other such delivery device.

The present invention further relates to a therapeutic dental gel composition in a physical form that, when used in conjunction with an optional dental delivery device such as a dental tray or strip, increases in viscosity upon placement in the oral cavity and thus prolongs the residence time of the composition in or on the delivery device.

The present invention still further relates to a therapeutic dental gel composition in packages that facilitate easy dispensing and application of said compositions into the oral cavity by a patient, dental practitioner, or consumer.

In another aspect of the present invention, a device, such as a push button or twist dispensing pen is used to provide an amount or dose of a therapeutic dental composition, such as a tooth whitener, an anti-caries agent, a fluoride gel, a breath freshener, or a tooth desensitizer, directly onto the tooth and/or gum surfaces by a consumer, patient, dentist or dental practitioner.

In yet another aspect of the present invention, a kit comprises at least one therapeutic dental gel composition, at least one set of instructions, and a applicator device or secondary composition that assists said therapeutic dental gel composition in its functional utility.

In yet another aspect of the present invention, a therapeutic dental gel composition provides two or more therapeutic ingredients within the same composition, or alternatively two or more therapeutic dental gel compositions, each providing a different therapeutic effect, within the same kit.

### BRIEF DESCRIPTION OF THE DRAWINGS

FIG. 1 is a graph depicting the viscometric properties of the therapeutic dental gel composition of the present invention (BTG) in comparison with two prior art gels.

FIG. 2 depicts one embodiment of a delivery device of the present invention.

FIG. 3 depicts another embodiment of a delivery device of the present invention.

FIG. 4 depicts a felt tip pen that may be utilized as a device for administering the therapeutic dental composition of the present invention.

FIG. 5 depicts a brush pen that may be utilized as a device for administering the therapeutic dental composition of the present invention.

FIG. 6 is a graph depicting the viscosities of several gel products diluted with water.

FIG. 7 is a bar graph illustrating the shade change of Group A subjects utilizing a composition of the present invention.

FIG. 8 is a bar graph illustrating the shade change of Group B subjects utilizing a composition of the present invention.

FIG. 9 is a bar graph illustrating the sensitivity reported by patients utilizing a composition of the present invention.

### DETAILED DESCRIPTION

A therapeutic dental gel composition is herein described as a responsive gel which may be dispensed from a device, which can be used to apply one or more therapeutic agents to the oral cavity. The dental composition can be held in the hand and used by a patient in need of a cosmetic or therapeutic dental treatment, or by a separate individual, such as a dentist, to apply to the oral cavity of a patient. In the case of patient self-use, it is advantageous, but not required, for the patient to use the dental composition to apply therapeutic agents to the teeth and/or gums by using a mirror to guide placement and contact of the dental composition in the mouth.

The dental composition can be held directly by the patient or dentist, or alternatively the dental composition may be placed in a holder or other such device. In either case, the dental composition may be placed in direct contact with the oral cavity surface in need of treatment, or alternatively it may be first placed in or on a delivery device, such as a dental tray or strip, said delivery device then used to carry the therapeutic dental gel composition into the oral cavity and thus into contact with the oral cavity surface or surfaces in need of cosmetic or therapeutic treatment. Prior to application to the oral cavity surface, the dental composition has a relatively low viscosity which permits easy dispensing from the delivery device. When applied to the oral cavity surface, the dental composition increases in viscosity to provide a more dilution-resistant gel when in contact with the tooth or gum surfaces. The gel will contain one or more therapeutic agents, and the therapeutic agents will be released from the gel over a period of time. The direction of agent release may be towards the oral cavity surface on which it is situated, towards the lumen of the oral cavity, away from the oral cavity surface on which it is situated, or both.

The dental composition of the invention is comprised of a responsive gel carrier and at least one therapeutic agent dispersed throughout the carrier. The therapeutic agent may be dissolved in the responsive gel carrier or simply dispersed homogeneously in the carrier as an insoluble suspended solid particulate. The therapeutic agent may also be emulsified with the responsive gel carrier, creating separate and discrete carrier and therapeutic agent phases within the composition. The emulsion may be either an agent-in-carrier emulsion or a carrier-in-agent emulsion, analogous to a water-in-oil or water-in-oil emulsion.

Therapeutic agents that are useful when applied to an oral cavity surface include those known to be effective against tooth decay or caries, tartar or calculus, dental plaque, halitosis, tooth stains, gingivitis, periodontal disease, oral ulcers and other diseases, afflictions or symptoms of the oral cavity. The therapeutic agent is placed in close proximity to the tissue surface, that is, dispersed or dissolved in a gel or gel film formed by contacting the inventive dental composition with the tissue surface.

The present invention describes a long-acting dental gel composition comprising: (1) a pharmaceutically acceptable, responsive gel carrier, (2) an orally or dentally therapeutic agent that is dissolved, dispersed or otherwise homogeneously distributed throughout said responsive gel carrier for the purpose of treating a disease, symptom or condition when applied to at least one surface of the oral cavity; and (3) optionally, auxiliary ingredients such as flavorants, humectants, sweeteners, surface active agents, pH adjusting agents, secondary therapeutic agents, opacifying agents, colorants and other product modifying or enhancing components.

The above composition may be applied to one or more surfaces in the oral cavity, such as the teeth or gums, to effect a therapeutic, curative or cosmetic effect on or around the surface contacted. The use of a responsive gel carrier increases the viscosity of the dental composition when applied to an oral cavity surface, thereby forming a gel and increasing the therapeutic agent's contact time with the oral cavity surface. Once in contact with the surface (tooth, gingival tissue, tongue, etc.), the inventive composition is then activated by the moisture in saliva by solubilizing, mobilizing or otherwise activating the oral care therapeutic agent dispersed in the carrier. The activated therapeutic agent thus slowly migrates out of the gel in the direction of the oral cavity surface, exerting the aforementioned therapeutic or cosmetic effect.

Longer contact times of the therapeutic agents with the oral cavity surface are achieved by the present invention over the less viscous or non-responsive compositions of the prior art. Lower concentrations of the therapeutic agent are thus possible than are conceivable with less viscous or non-responsive compositions, as much of the therapeutic agent in a less viscous composition migrates away from the intended treatment area after being dispensed to the oral cavity and/or solubilized in saliva.

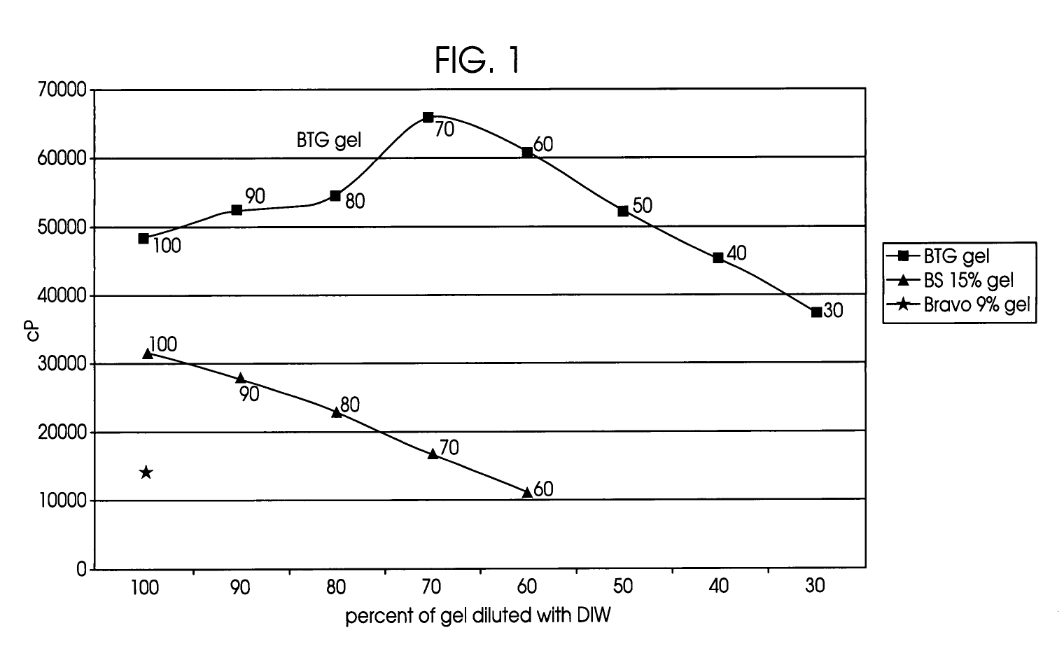

Carriers: The responsive gel carrier may contain any number of ingredients that alter the viscosity of a composition in response to the presence of moisture and, optionally, in response to changes in temperature, pH and/or ionic strength. The carrier of the present invention may include one or more ingredients that are sensitive to the presence of moisture or to changes in temperature, pH, or ionic strength. Examples of ingredients that are sensitive to the presence of moisture are complexes of high molecular weight acid functional polymers in combination with vinylpyrrolidone polymers (such as polyvinylpyrrolidone (PVP)) and copolymers. Surprisingly, it has been found that aqueous solutions of high concentrations of carboxypolymethylene, in the presence of PVP, do not achieve the high viscosities normally observed when adjusted to a pH range of between about 4.0 and 7.0. Upon dilution with water, however, these carboxypolymethylene/PVP complexes surprisingly demonstrate an increase in viscosity, rather than a decrease in viscosity as would be expected of most aqueous compositions. In particular, such carboxypolymethylene/PVP complexes achieve unexpectedly low viscosities in the presence of a water-soluble salts, including but not limited to alkali metal salts such as sodium and potassium salt and/or ammonium salt. The increase in viscosity of this novel complex upon contact with moisture (for instance from saliva or residing as a film on a tooth or gum surface) has great utility in formulating the moisture-responsive dental gels of the present invention. An example of this novel viscometric property is shown in FIG. 1.

Prior to exposure with water, the carriers of the present invention have low viscosity to permit easy dispensing of the therapeutic dental composition from the delivery device. The viscosity depressive effect of the carboxypolymethylene/PVP complex carrier is dependent upon the presence of an water soluble salts. Without the presence of the water soluble salts. , the complex carrier exhibits a high viscosity. Water soluble salts that may be utilized in maintaining a low viscosity in the present invention include but are not limited to sodium saccharin, sodium chloride, potassium chloride, and ammonium chloride may be utilized in the present invention as the source of water soluble salts.

The moisture sensitive polymer or polymer complex may be present in an amount of from about 0.01 to about 20% of the dental composition, more preferably from about 0.01% to about 10% of the dental composition. More particularly, the concentration of moisture sensitive polymer or polymer complex in the dental composition may be about 0.01%, 0.02%, 0.03%, 0.04%, 0.05%, 0.06%, 0.07%, 0.08%, 0.09%, 0.1%, 0.2%, 0.3%, 0.4%, 0.5%, 0.6%, 0.7%, 0.8%, 0.9%, 1.0%, 1.5%, 2.0%, 2.5%, 3.0%, 3.5%, 4.0%, 4.5%, 5.0%, 5.5%, 6.0%, 6.5%, 7.0%, 7.5%, 8.0%, 8.5%, 9.0%, 9.5%, 10.0%, 10.5%, 11.0%, 11.5%, 12.0%, 12.5%, 13.0%, 13.5%, 14.0%, 14.5%, 15.0%, 15.5%, 16.0%, 16.5%, 17.0%, 17.5%, 18.0%, 18.5%, 19.0%, 19.5%, 20.0%, 20.5%, 21.0%, 21.5%, 22.0%, 22.5%, 23.0%, 23.5%, 24.0%, 24.5%, 25%, 25.5%, 26.0%, 26.5%, 27.0%, 27.5%, 28.0%, 28.5%, 29.0%, 29.5%, 30.0% weight to weight of the dental composition.

As used herein, pH sensitive polymers mean any polymer that gels in response to an increase in pH. Examples of water-soluble ingredients sensitive to pH and ionic strength include, but are not limited to, carboxypolymethylene (Carbopol®, Noveon), hydrolyzed or unhydrolyzed PVP/maleic acid anhydride copolymer (Gantrez, ISP), polycarboxylates, gellan gum (Gelrite, CP Kelco), poly(methyl methacrylate-co-methacrylic acid) (such as Eudragit, Rohm Pharma), hydroxypropyl methylcellulose phthalate, and cellulose acetate phthalate. Suitable polycarboxylates include but are not limited to polymers and copolymers of acrylic acid, methacrylic acid, maleic acid (or maleic anhydride), fumaric acid, itaconic acid, aconitic acid, mesaconic acid, citraconic acid and methylenemalonic acid, mellitic acid, succinic acid, oxydisuccinic acid, polymaleic acid, benzene 1,3,5-tricarboxylic acid, carboxymethyloxysuccinic acid, and soluble salts thereof.

As used herein, temperature sensitive polymer shall mean any polymer that gels in response to increase in temperature above about 30 degrees Celsius. Temperature sensitive ingredients may include but are not limited to methylcellulose, hydroxypropyl methylcellulose, ethyl(hydroxyethyl)cellulose (in the presence of ionic surfactants), and polyoxyethylene-polyoxypropylene block copolymers (such as Pluronic F-127 and F-108, BASF).

The pH or ion sensitive ingredient may be present in an amount of from about 0.01 to about 20% of the dental composition, more preferably from about 0.01% to about 10% of the dental composition. More particularly, the concentration of pH or ion sensitive ingredient in the dental composition may be about 0.01%, 0.02%, 0.03%, 0.04%, 0.05%, 0.06%, 0.07%, 0.08%, 0.09%, 0.1%, 0.2%, 0.3%, 0.4%, 0.5%, 0.6%, 0.7%, 0.8%, 0.9%, 1.0%, 1.5%, 2.0%, 2.5%, 3.0%, 3.5%, 4.0%, 4.5%, 5.0%, 5.5%, 6.0%, 6.5%, 7.0%, 7.5%, 8.0%, 8.5%, 9.0%, 9.5%, 10.0%, 10.5%, 11.0%, 11.5%, 12.0%, 12.5%, 13.0%, 13.5%, 14.0%, 14.5%, 15.0%, 15.5%, 16.0%, 16.5%, 17.0%, 17.5%, 18.0%, 18.5%, 19.0%, 19.5%, 20.0%, 20.5%, 21.0%, 21.5%, 22.0%, 22.5%, 23.0%, 23.5%, 24.0%, 24.5%, 25%, 25.5%, 26.0%, 26.5%, 27.0%, 27.5%, 28.0%, 28.5%, 29.0%, 29.5%, 30.0% weight to weight of the dental composition.

The temperature sensitive ingredient may be present in an amount of from about 0.01% to about 20% of the dental composition, more preferably from about 0.01% to about 10.0% of the dental composition. More particularly, the concentration of temperature sensitive ingredient in the dental composition may be about 0.01%, 0.02%, 0.03%, 0.04%, 0.05%, 0.06%, 0.07%, 0.08%, 0.09%, 0.1%, 0.2%, 0.3%, 0.4%, 0.5%, 0.6%, 0.7%, 0.8%, 0.9%, 1.0%, 1.5%, 2.0%, 2.5%, 3.0%, 3.5%, 4.0%, 4.5%, 5.0%, 5.5%, 6.0%, 6.5%, 7.0%, 7.5%, 8.0%, 8.5%, 9.0%, 9.5%, 10.0%, 10.5%, 11.0%, 11.5%, 12.0%, 12.5%, 13.0%, 13.5%, 14.0%, 14.5%, 15.0%, 15.5%, 16.0%, 16.5%, 17.0%, 17.5%, 18.0%, 18.5%, 19.0%, 19.5%, 20.0%, 20.5%, 21.0%, 21.5%, 22.0%, 22.5%, 23.0%, 23.5%, 24.0%, 24.5%, 25%, 25.5%, 26.0%, 26.5%, 27.0%, 27.5%, 28.0%, 28.5%, 29.0%, 29.5%, 30.0% weight to weight of the dental composition.

Additionally, the responsive gel carrier of the therapeutic dental gel composition may include water in an amount of from about 1.0% to about 99.9% of the dental gel composition, more preferably from about 10.0% to about 98.7% of the dental gel composition. The carrier may further include a polyol that assists in water retention and/or modifying the gelling temperature of the therapeutic dental composition. Examples of polyols include but are not limited to glycerin, propylene glycol, polyethylene glycol, mannitol, sorbitol, maltitol, and others. The polyol may be present in the therapeutic dental gel composition in an amount from about 1.0% to about 50.0%.

The concentration of responsive gel carrier in the dental composition may be about 10%, 15%, 20%, 25%, 30%, 35%, 40%, 45%, 50%, 55%, 60%, 65%, 70%, 75%, 80%, 85%, 90%, 95%, 96%, 97%, 98%, 99% weight to weight of the dental composition.

Therapeutic agents: Therapeutic agents contemplated to be included in the carriers of the present invention include antimicrobial agents, tooth whiteners, anti-inflammatory agents, tooth desensitizers, anticaries agents, tartar control agents, tooth and gum surface protectants, tooth stain prevention agents and agents effective against dental plaque, halitosis, gingivitis, periodontal disease, oral ulcers and other diseases, afflictions or symptoms of the oral cavity.

Suitable antimicrobial agents known or anticipated to have utility in the inventive compositions include compounds with inhibitory activity against microorganisms found in the oral cavity. Compounds such as triclosan, chlorhexidine salts (such as chlorhexidine digluconate), cetylpyridinium chloride and domiphen bromide are suitable antimicrobial agents useful in the present inventive compositions.

Suitable tooth whitening agents include one or more peroxide-containing compounds, or more broadly, oxidizing compounds. Such oxidizing compounds include alkali metal percarbonates, carbamide peroxide, sodium perborate, potassium persulfate, calcium peroxide, zinc peroxide, chlorine dioxide, sodium chlorite, hydrogen peroxide complexes and hydrogen peroxide.

Suitable anticaries agents include but are not limited to a source of fluoride ion. Fluoride sources include sodium fluoride, potassium fluoride, calcium fluoride, stannous fluoride, stannous monofluorophosphate and sodium monofluorophosphate. These sources should release anywhere from about 25 to about 3500 ppm of fluoride ion. The anti-caries agent may be present in an amount from about 0.05% to about 3.0%, preferably about 0.2% to about 1.0% by weight of the dental composition.

Suitable tartar control agents include but are not limited to zinc salts (e.g. zinc citrate trihydrate) and agents containing phosphorous (e.g. sodium tripolyphosphate). Inorganic phosphorous tartar control agents may include any of the pyrophosphates such as disodium pyrophosphate, dipotassium pyrophosphate, tetrapotassium pyrophosphate, tetrasodium pyrophosphate and mixtures thereof. Organic phosphorous compounds that may serve as tartar control agents include polyphosphonates such as disodium ethiarne-1-hydroxy-1,1-diphosplhonate (EHDP), methanediphosphonic acid, and 2-phosphonobutane-1,2,4-tricarboxylic acid. Amounts of the polyphosphate may range from about 0.5% to about 20.0%, preferably from about 1.0% to about 8.0%, optimally from about 1.2% to about 4.5% by weight of the dental composition. As an alternative to phosphates, zinc salts may be utilized as anti-tartar agents. Most preferred is zinc citrate trihydrate. Amounts of the zinc salt may range from about 0.5% to about 20%, preferably from about 1.0 to about 8.0%, optimally from about 2.0% to about 6.0% by weight of the dental composition.

The concentration of therapeutic agent in the dental composition may be about 0.01%, 0.02%, 0.03%, 0.04%, 0.05%, 0.06%, 0.07%, 0.08%, 0.09%, 0.1%, 0.2%, 0.3%, 0.4%, 0.5%, 0.6%, 0.7%, 0.8%, 0.9%, 1.0%, 1.5%, 2.0%, 2.5%, 3.0%, 3.5%, 4.0%, 4.5%, 5.0%, 5.5%, 6.0%, 6.5%, 7.0%, 7.5%, 8.0%, 8.5%, 9.0%, 9.5%, 10.0%, 10.5%, 11.0%, 11.5%, 12.0%, 12.5%, 13.0%, 13.5%, 14.0%, 14.5%, 15.0%, 15.5%, 16.0%, 16.5%, 17.0%, 17.5%, 18.0%, 18.5%, 19.0%, 19.5%, 20.0%, 20.5%, 21.0%, 21.5%, 22.0%, 22.5%, 23.0%, 23.5%, 24.0%, 24.5%, 25%, 25.5%, 26.0%, 26.5%, 27.0%, 27.5%, 28.0%, 28.5%, 29.0%, 29.5%, 30.0%, 30.5%, 31.0%, 31.5%, 32.0%, 32.5%, 33.0%, 33.5%, 34.0%, 34.5%, 35.0%, 35.5%, 36.0%, 36.5%, 37.0%, 37.5%, 38.0%, 38.5%, 39.0%, 39.5%, 40.0%, 40.5%, 41.0%, 41.5%, 42.0%, 42.5%, 43.0%, 43.5%, 44.0%, 44.5%, 45.0%, 45.5%, 46.0%, 46.5%, 47.0%, 47.5%, 48.0%, 48.5%, 49.0%, 49.5%, 50% weight to weight of the composition.

Auxiliary Ingredients: Auxiliary ingredients contemplated to be included in the compositions of the present invention include flavorants, humectants, sweeteners, surface active agents, pH adjusting agents, stabilizing agents, secondary therapeutic agents, opacifying agents, colorants and other product modifying or enhancing components.

Suitable flavorants include but are not limited to oils derived from plants and fruits such as citrus oils, fruit essences, mint, peppermint oil, spearmint oil, capsaicin, clove oil, oil of wintergreen, anise, sassafras, sage, eucalyptus, marjoram, cinnamon, lemon, orange, banana, cherry, apple, pineapple, grape, strawberry, blueberry, tutti frutti, methyl salicylate, Hagelin flavoring #640047, Hagelin flavouring #640057, Hagelin flavouring #671009, Hagelin flavoring #671010, and the like. Those skilled in the art will recognize that natural and artificial flavoring agents may be used independently or combined in any sensorially acceptable blend.

Suitable humectants include but are not limited to glycerin, sorbitol, zylitol, mannitol, lactitol, maltitol, and other sugar alcohols, polyethylene glycol, propylene glycol, and other edible polyhydric alcohols and mixtures thereof.

Suitable sweeteners include but are not limited to sucrose, lactose, dextrose, maltose, dextrin, dried inverted sugar, fructose, levulose, galactose, corn syrup and their solids, sorbitol, mannitol, xylitol, hydrogenated starch hydrolysates, maltitol, sucralose, aspartame, salts of acesulfame, alitame, saccharin and its salts, cyclamic acid and its salts, glycyrrhizin, dihydrochalcones, thaumatin, monellin, stevia extract and the like.

Suitable surface active agents include but are not limited to sodium lauryl sulfate, condensates of sorbitan mono-oleate with from about 20 to 60 moles of ethylene oxide (e.g., “Tweens” a trademark of ICI United States, Inc.), condensates of ethylene oxide with propylene oxide and condensates of propylene glycol (“Pluronics” a trademark of BASF-Wyandotte Corp.).

Suitable pH adjusting agents include but are not limited to sodium hydroxide, potassium hydroxide, ammonium hydroxide, sodium carbonate, potassium carbonate, TRIS and triethanolamine.

Suitable stabilizing and/or chelating agents include but are not limited to EDTA and its salts, citric acid and its salts, gluconic acid and its salts, etidronic acid (Dequest 2010), alkali metal pyrophosphates and alkali metal polyphosphates.

Suitable opacifying agents include but are not limited to titanium dioxide and zinc oxide.

Suitable colorants include but are not limited to FD and C-type dyes and lakes, fruit and vegetable extracts, titanium dioxide, and the like, alone or in combination.

Prior to application to the oral cavity, at room temperature (approximately 25° C.), the therapeutic dental gel composition is in an easily applied form, such as a liquid or gel, having a pH from about 2.5 to about 9.0, preferably from about 4.0 to about 6.0. When the composition is applied to the oral cavity, the viscosity increases in response to the presence of moisture, and optionally to an increase in pH, ionic strength and/or temperature within the oral cavity.

Additional carriers, therapeutic agents and excipients useful in the invention are listed in Remington's, The Science and Practice of Pharmacy (2000); Lieberman et al., Pharmaceutical Dosage Forms (2d ed. 1989); Merck Index (13th Ed.).

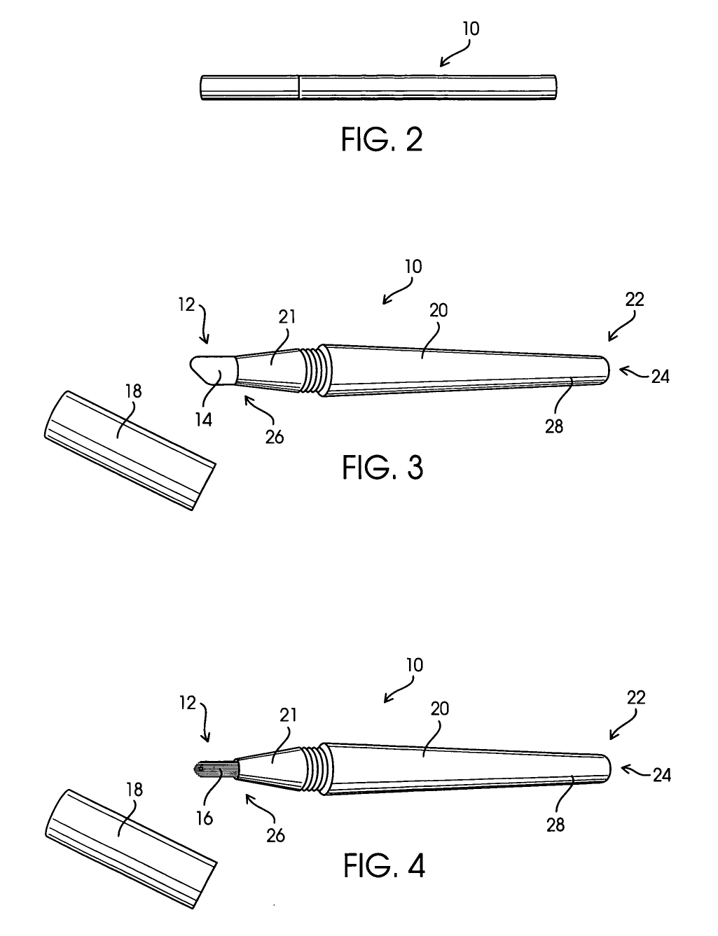

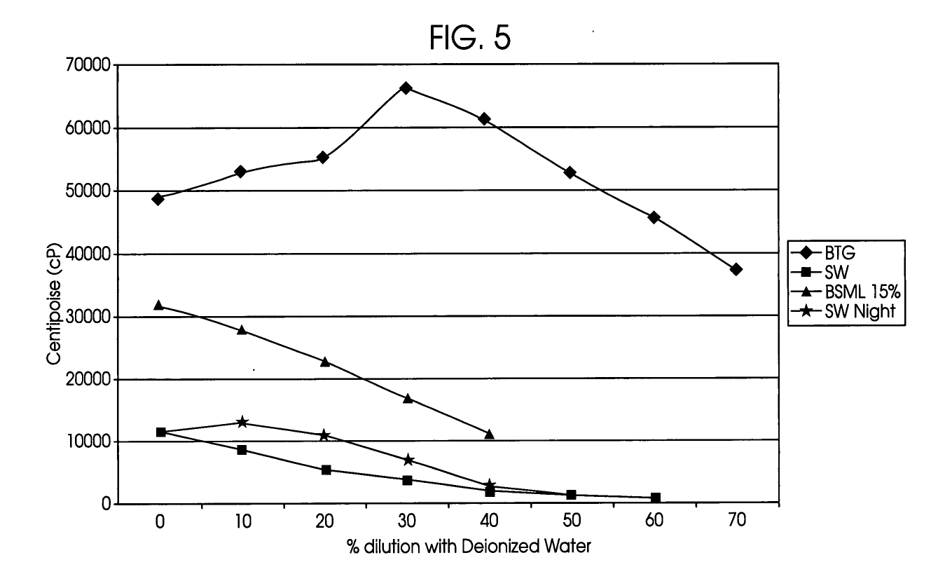

The inventive compositions are preferably disposed in a delivery device 10 (e.g., FIGS. 2-5), such as a dispensing tube, pencil, pen or liquid stick having an applicator 12, such as a felt tip 14 (FIG. 4), brush 16 (FIG. 5), roller ball, or non-woven pad. In one embodiment, the delivery device 10 includes more than one applicator 12 that may be removably engaged with the device 10. In an embodiment wherein the device 10 is a pen or a pencil, the applicator 12 may be retractable and/or housed in a cap 18. The therapeutic dental composition of the present invention may be housed directly within a reservoir 20 in the device 10 or may be supplied in a removable cartridge (not shown) within the reservoir 20 that may be replaced or refilled. The delivery device 10 may dispense the therapeutic dental composition through a transfer channel 21 through capillary action, such as in a flow through pen, or through an activator 22, such as mechanical piston with a click mechanism, twist button and ratchet mechanism, or push button mechanism, or through a vacuum method of ejection, or through other such mechanical means for transferring the composition from the device to an oral cavity surface in need of treatment. The activator 22 may be present on first end 24 of the device 10 and the applicator on a second end 26 of the device 10 or the activator 22 may be present on a side wall 28 of the device. In one embodiment, the delivery device 10 includes a felt tip 14 or brush 16 applicator 12 wherein the inventive composition is dispensed to the applicator 12 through actuation of the activator 22, such as by a clicking or twisting mechanism. Kotobuke Pencil, Japan, is one manufacturer of such types of delivery devices 10.

Preferably, the device 10 is free of metal components, more preferably made of plastic components. In one embodiment, the device is made from fluoropolymers, polypropylene, polyethylene, or other such polymers that are compatible with the ingredients of the composition of the present invention.

Upon applying external pressure to the activator 22 to expel the composition from the reservoir 20, the dental composition responds to shear forces introduced by the external pressure, and is temporarily reduced in viscosity to allow for ease of movement of the composition from the reservoir 20 through the transfer channel 21 to the applicator 12. Once the composition is positioned on the applicator 12, the user applies the composition to the teeth or gum surfaces, using the applicator 12 to apply and distribute the composition on the teeth and/or gums. Optionally, a set of instructions may be provided to the user in order that a particular application method or protocol be employed to apply the composition from the device 10 onto the teeth and/or gums in order to optimize the performance of the composition. With a twist mechanism, the user twists the activator 22 on the first end 24 of the delivery device 10 and the therapeutic dental composition travels from the reservoir 20 through the transfer channel 21 to the applicator 12 at the other end. With the push button activator 22, the therapeutic dental composition is delivered to the oral cavity surface with the push of a button activator 22 on the first end 24 or side wall 28, which transfers the composition from the reservoir 20 through the transfer channel 21 to the applicator 12.

The delivery devices 10 of the present invention may deliver a dose of the therapeutic dental composition upon each application to an oral cavity surface, for example, with each click or twist of the activator mechanism 22. The dose includes from about 0.01 ml to about 3.0 ml of the composition, preferably from 0.1 ml to about 1.0 ml, more preferably from 0.1 ml to about 0.5 ml, and most preferably from 0.2 ml to about 0.3 ml of the composition. In one embodiment, the amount of dose dispensed from the device 10 may be adjusted by the user.

The dental gel composition can be dispensed from any suitable delivery device 10 as described above. For example, the dental composition may be dispensed as a liquid or thin gel from a push button or twist actuated pen with an advancing piston mechanism that expels a predetermined amount of liquid or gel through an orifice. The pen delivery device 10 just described may also optionally comprise a set of bristles, advantageously positioned near or around the orifice through which the therapeutic dental liquid or gel is expelled. Expelling the therapeutic liquid or gel through the orifice and onto said bristles, the user may apply the therapeutic composition directly onto the teeth, thereby forming a thickened gel upon application. Alternatively, the dental composition may be brushed onto an oral cavity surface, using a brush (FIG. 5) or felt tip (FIG. 4) that is replenished with the therapeutic composition by returning it to a reservoir containing said composition or by clicking or twisting a dispensing portion of the reservoir. Yet another mode of application is placement of the inventive therapeutic liquid or gel composition into a dental tray, whereupon the dental tray is inserted into place around a patient's teeth. Plastic strips may also be coated with a predetermined dose of the therapeutic responsive dental gel and placed against the teeth or gums of a subject. Alternatively, the inventive compositions may be applied by placing an amount on a swab or other such device, and simply applying directly to the intended oral cavity surface.

Methods of using the above compositions and devices are also contemplated. One such method involves identifying an oral cavity surface in need of treatment, applying the therapeutic responsive gel dental composition described herein, and leaving said composition in contact with the oral cavity surface for a period of time sufficient to exert a therapeutic effect. Application of the composition in accordance with such a method may be performed, for instance, only once, or alternatively may be performed on a regularly scheduled basis, for instance once a day for two weeks. Further, application of the composition may occur more than once a day for varying intervals of time. For example, the therapeutic dental composition may be administered to a subject one to six times per day, for a period of time ranging from 30 seconds to 2 hours per application. In one embodiment, the composition is administered two times a day for fifteen minutes per application. In another embodiment, the composition is administered three times a day for fifteen minutes per application. It is also contemplated that the inventive compositions may be used on a daily basis, for instance, as a means of preventing tooth decay by including a fluoride ion-containing therapeutic agent in the composition. Sequential or concomitant application of two complementary, reactive or incompatible compositions is also contemplated, whereby at least one of the applied compositions possesses the inventive elements described above and disclosed elsewhere in this specification.

In yet another embodiment, the therapeutic dental composition of the present invention may be used as a pre-treat or maintenance tool as a follow-up to in-office dental procedure, including but not limited to the procedures disclosed in U.S. Pat. No. 6,343,933 and PCT Publication No. WO 01/51005.

The present invention further contemplates kits comprising at least one therapeutic dental gel composition as described above, a delivery device, and at least one set of instructions. In one embodiment, the fit further includes a secondary composition that assists the therapeutic dental gel composition in its functional utility.

It is believed that one skilled in the art, based on the description herein, can utilize the present invention to its fullest extent. The following specific examples are therefore to be construed as merely illustrative, and not limitative of the remainder of the disclosure in any way whatsoever.

### EXAMPLE 1

A therapeutic dental gel composition is prepared according to the following formula:

| | Percent by |
|---|---|
| Ingredient | Weight |
| Water | 61.300 |
| Glycerin (Dow) | 5.000 |
| 1-hydroxyethylidine-1, 1-diphosphonic acid (Dequest 2010, | 0.500 |
| Solutia) | |
| Potassium Stannate Trihydrate (Goldschmidt) | 0.100 |
| Sodium Saccharin | 0.600 |
| Hydrogen peroxide (35% w/w solution from Solvay) | 15.000 |
| Carbopol 974P (Noveon) | 5.000 |
| PVP (Kollidon 25, BASF) | 5.000 |
| PEG-60 Hydrogenated Castor Oil (Cremaphor RH60, BASF) | 4.000 |
| Flavor | 1.000 |
| Ammonium Hydroxide (29% Solution) | 2.500 |
| Total | 100.000 |

Manufacturing Method:

Combine water and glycerin, add Dequest 2010, potassium stannate trihydrate and sodium saccharin; mix until completely dissolved. Add hydrogen peroxide solution and mix well. Add Carbopol all at once, mix with high agitation to disperse and dissolve. Transfer to planetary mixer and continue mixing until smooth. Adjust pH to 5.2-5.5 with ammonium hydroxide, added drop-wise over a period of at least 10 minutes. Add PVP all at once, mix until smooth (mix will lose much of the viscosity developed after Carbopol neutralization). Heat Cremophor RH-60 to melt, add flavor and mix. Add Creomophor/flavor blend, mix thoroughly and deaerate. Transfer to bulk containers or fill into syringes, brush or felt tip pens (FIGS. 2-5), or other suitable delivery device.

### EXAMPLE 2

A therapeutic dental gel composition is prepared according to the guidelines in Table 1:

TABLE 1
Therapeutic Dental Gel Composition

| Ingredient | Examples | Function in Product | Percent (w/w) |
|---|---|---|---|
| Water | Water | Diluent/Carrier Fluid | 10-98.7% |
| Moisture Sensitive | carboxypolymethylene/PVP | Thickens product in the presence | 0.01%-50% |
| Polymer Complex | | of additional moisture | |
| Optional pH/Ion | carboxypolymethylene | Thickens in response to increase in | 0.01-10% |
| Sensitive Polymer | | pH | |
| | PVP/maleic acid anhydride | | |
| | copolymer | | |
| | Polycarboxylates | | |
| | Gellan gum | | |
| | Cellulose acetate phthalate | | |
| Optional Temperature | Methylcellulose | Gels in response to increase in | 0.01%-10% |
| Sensitive Polymer | | temperature above about 30° C. | |
| | Hydroxypropyl | | |
| | methylcellulose | | |
| | Poly(oxyethylene)- | | |
| | poly(oxypropylene) block | | |
| | copolymer | | |
| Optional Polyol | Glycerin | Water retention/gel texture | 1-50% |
| | | modification | |
| | Propylene Glycol | | |
| | Polyethylene Glycol | | |
| | Sorbitol | | |
| | Mannitol | | |
| Therapeutic Agent | Sodium fluoride | Anticaries | 0.01-20% |
| | Hydrogen peroxide | Tooth whitening/antibacterial | |
| | Chlorhexidine digluconate | Antiplaque/antigingivitis | |
| | Sodium tripolyphosphate | Tartar control | |
| | Potassium nitrate | Tooth desensitizser | |

### EXAMPLE 3

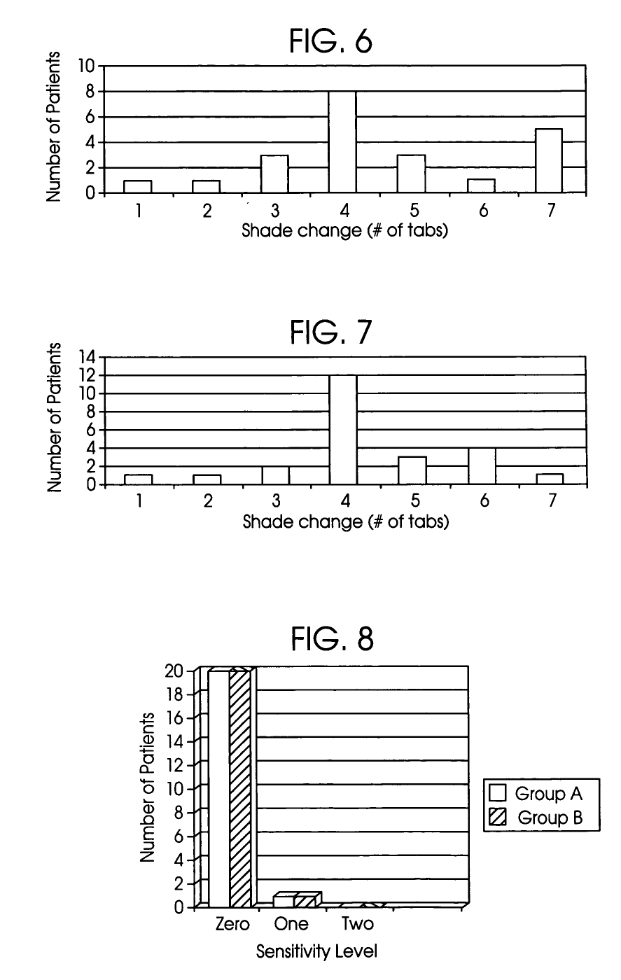

The dilution viscosity of the therapeutic dental composition of Example 1 was compared to several different gels. The measurements were made with a Brookfield Cone-Plate Viscometer at approximately 25 degrees Celsius. The results are depicted in FIG. 6. In FIG. 6, “BTG” represents the inventive composition of Example 1, while SW and SW Night (Simply White and Simply White Night) are Colgate's commercial brush-on products, and the BSML 15% is the current BriteSmile 15% Procedure Gel. As depicted in FIG. 6, the viscosity of BTG increases to a peak of approximately 65,000 cP as the composition is diluted to up to approximately 30%, whereas the viscosities of the prior art compositions decrease as dilution increases.

### EXAMPLE 4

The effect of the presence of various salts on the viscosity of the therapeutic dental compositions in Table 2 was assessed.

TABLE 2

| | Percent (w/w) | | | |
|---|---|---|---|---|
| Ingredient | Form. 1 | Form. 2 | Form. 3 | Form. 4 |
| Water | 67.837 | 70.900 | 66.900 | 61.900 |
| Glycerine 99.7% | 5.000 | 5.000 | 5.000 | 5.000 |
| Etidronic acid | 0.300 | 0.500 | 0.500 | 0.500 |
| Sodium acid pyrophosphate | 0.100 | | | |
| Potassium Stannate Trihydrate | 0.020 | 0.100 | 0.100 | 0.100 |
| H2O2 (35% solution) | 17.143 | 15.000 | 15.000 | 15.000 |
| Carbopol 974P-NF | 5.000 | 5.000 | 5.000 | 5.000 |
| PVP K-25 | | 1.000 | 5.000 | 10.000 |
| Ammonium Hydroxide 29% | 4.600 | 2.500 | 2.500 | 2.500 |
| Total | 100.000 | 100.000 | 100.000 | 100.000 |

The measurements were made with a Brookfield Cone-Plate Viscometer at approximately 25° C. The results are depicted in Table 3. As depicted in Table 3, the viscosity of formulations 3 and 4, which included 5.0% Carbopol/5.0% PVP and 5.0% Carbopol/10.0% PVP, respectively, significantly decreased in the presence of an alkali metal ion. The alkali metal ion did not have a significant effect on viscosity, however, in Formulations 1 and 2, which included 5.0% Carbopol in combination with 1.0% or no PVP.

TABLE 3

| | Percent | Percent | Percent | Percent | Percent | |
|---|---|---|---|---|---|---|
| Formulation | Carbopol 974P | PVP K-25 | Na Saccharin | NaCl | KCl | Viscosity(cps) |
| 1 | 5.00% | 0.00% | | | | 130,000 |
| | 5.00% | 0.00% | 0.60% | | | 115,000 |
| | 5.00% | 0.00% | | 0.60% | | 113,000 |
| | 5.00% | 0.00% | | | 0.60% | 110,000 |
| 2 | 5.00% | 1.00% | | | | 128,000 |
| | 5.00% | 1.00% | 0.60% | | | 123,000 |
| | 5.00% | 1.00% | | 0.60% | | 126,000 |
| | 5.00% | 1.00% | | | 0.60% | 131,000 |
| 3 | 5.00% | 5.00% | | | | 143,000 |
| | 5.00% | 5.00% | 0.60% | | | 67,521 |
| | 5.00% | 5.00% | | 0.60% | | 72,078 |
| | 5.00% | 5.00% | | | 0.60% | 53,438 |
| 4 | 5.00% | 10.00% | | | | 145,000 |
| | 5.00% | 10.00% | 0.60% | | | 43,081 |
| | 5.00% | 10.00% | | 0.60% | | 50,952 |
| | 5.00% | 10.00% | | | 0.60% | 47,224 |

### EXAMPLE 5

Clinical trial was conducted with 44 subjects to study the efficacy and safety of the formulation provided in Example 1, a 5.25% hydrogen peroxide gel, supplied in a brush-on pen for vital tooth bleaching. The objective of the study was to test the efficacy of the whitening pen as well as patient compliance due to its ease of use. The secondary objective was to evaluate any sensitivity of teeth or possible effect on the tissues of the oral cavity.

Method:

The investigation divided the subjects into two groups A and B, each including 22 subjects. Subjects in Groups A & B completed a medical, dental history as well as informed consent forms. This was followed by an interview, oral examination and an evaluation of the teeth shade using the Vita Pan Shade Guide. A random population was chosen with the majority having an average pre-whitening shade of A-3 (tab 9) as measured on the Vita Pan Shade Guide. Pregnant or nursing women and those subjects with severe or moderate periodontal disease and any other medical or dental complications were excluded. If enrolled, the shade was recorded and photographed using the Polaroid SLR 5 camera. Special attention was paid to keep the lighting constant in the same operating room, as well as maintaining identical settings on the camera.

The patients in group A were given the brush-on pen with instructions to apply the gel twice daily every day except Sundays for two weeks. Group A patients were instructed to apply a thin film on tooth numbers 4 through 13 and 20 through 29. The patients were asked not to eat or drink anything for at least 15 minutes post application. Group A was instructed to contact the Center with any sensitivity issues or any other compliance questions.

Group B patients were instructed to visit the La Jolla BriteSmile Center twice daily for two weeks except Sundays since the Center was closed. Those in Group B had the gel placed on by a clinical investigator at the La Jolla BriteSmile Center and given the same instructions to not eat or drink anything for at least 15 minutes post application. Those in Group B were evaluated daily for sensitivity and any signs of oral irritations.

The shade changes for Groups A and B were evaluated at the conclusion of the study using the Vita Pan Shade in the following order of lightest to darkest: B1, A1, B2, D2, A2, C1, C2, D4, A3, D3, B3, A3.5, B4, C3, A4, C4. These shades were then assigned a numeric number of 1 through 16, B1 being number 1.

Results:

This study demonstrated an average improvement of 5 shades as measured on the Vita Shade Guide. No sensitivity or any other complications were noted in any of the subjects.

The results of the efficacy were analyzed using the Vita Pan Shade Guide with numerical values of 1 through 16.

Table 4 shows the average shade change statistics for groups A and B.

| | | Average Shade |
|---|---|---|
| | Average Shade | change (A3 |
| Group | change (total) | and darker) |
| A | 4.5 +/− 1.7 | 5.1 +/− 1.6 |
| B | 4.3 +/− 1.3 | 4.6 +/− 1.3 |
| P values (T-test)* | 0.29 | 0.21 |

*P-values suggest that the populations are more likely to be similar than not and that patient compliance was high.

As shown in Table 4 and depicted in FIGS. 7 and 8, these results demonstrate that the formulation of Example 1 produced an average of 5 shades for patients A3 and darker and 4.5 shades for the total sample. This can be compared to an average shade change of 9.3 shades for the BriteSmile one-hour whitening treatment for patients A3 and darker as disclosed in U.S. Pat. No. 6,343,933. Further, the results are similar to the results of tray products used for 8-10 hours per night for 10 days (see “A Comparison of Tooth Whitening by Four Procedures”, Forsyth Institute, 2002).

The safety was analyzed by evaluating the effect on the oral tissue and by measuring the sensitivity that was reported. The final oral exam evaluated the lips, the palate, the gingival mucosa and surrounding tissue and glands as well as a complete oral cancer screen. The sensitivity was evaluated by reporting none, mild, moderate or severe with each given a numerical value of 0 to 3 with severe being 3.

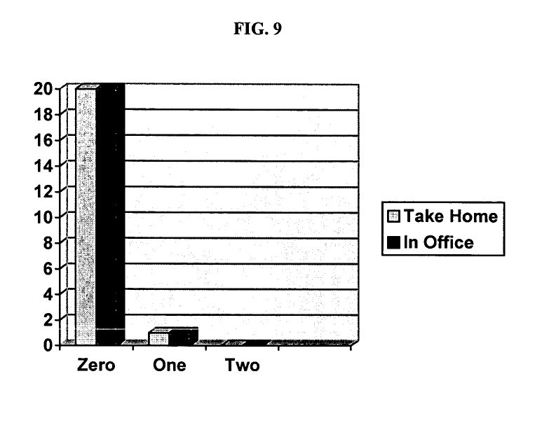

As shown in FIG. 9, basically no oral irritation was noted on any of the subjects. Only two patients claimed of possible mild sensitivity experienced only once by each.

Discussion:

The efficacy of the 5% hydrogen peroxide gel of Example 1 in the brush-on pen was measured for both Group A and Group B using the Vita Pan Shade Guide scores. The average shade improvement was not significantly different between both groups and averaged 5 shades for patients A3 and darker and 4.5 shades for the total sample. Both groups reported no sensitivity. Every participant in the study noticed an improvement subjectively and some indicated that they started noticing improvement within days of using the brush-on pen.

The results are significant in both the efficacy and the low percentage of sensitivity when compared to any other available tooth whitening product. Also given the similarity in shade improvement of both Groups this maybe indicative of good patient compliance. On an exit interview patients rated the brush-on pen as an 8+ on a scale of 1-10, 10 being highest.

A number of embodiments of the invention have been described. Nevertheless, it will be understood that various modifications may be made without departing from the spirit and scope of the invention. Accordingly, other embodiments are within the scope of the following claims, and as various changes can be made to the above compositions, formulations, combinations, and methods without departing from the scope of the invention, it is intended that all matter contained in the above description be interpreted as illustrative and not in a limiting sense. All patent documents and references listed herein are incorporated by reference.

1. A liquid oral therapeutic dental composition, that increases in viscosity upon contact with moisture following application to an oral cavity surface, comprising:
a moisture responsive gel carrier comprising a moisture sensitive polymer complex and a water-soluble salt; and
a therapeutic agent dispersed in the responsive gel carrier.

2. The composition of claim 1, wherein the moisture responsive gel carrier further comprises a thermally responsive polymer.

3. The composition of claim 1, wherein the moisture responsive gel carrier further comprises a pH or ion responsive polymer.

4. The composition of claim 1, wherein the therapeutic agent is selected from the group consisting of antimicrobial agents, tooth whiteners, anti-inflammatory agents, tooth desensitizers, anticaries agents, tartar control agents, tooth and gum surface protectants, tooth stain prevention agents and agents effective against dental plaque, halitosis, gingivitis, periodontal disease, oral ulcers and other diseases, afflictions or symptoms of the oral cavity.

5. The composition of claim 1, wherein the therapeutic agent comprises a tooth whitener.

6. The composition of claim 5, wherein the tooth whitener is selected from the group consisting of an alkali metal percarbonate, carbomide peroxide, sodium perborate, potassium persulfate, calcium peroxide, zinc peroxide, chlorine dioxide, sodium chlorite, a hydrogen peroxide complex, hydrogen peroxide and mixtures of any of the foregoing.

7. The composition of claim 5, wherein the tooth whitener comprises about 0.01% (w/w) to about 20.0% (w/w) of hydrogen peroxide.

8. The composition of claim 5, wherein the tooth whitener comprises about 2.0% (w/w) to about 30.0% (w/w) of carbamide peroxide.

9. The composition of claim 1, further comprising water present in an amount of about 10.0% (w/w) to about 98.7% (w/w) of the composition.

10. The composition of claim 1, wherein the moisture responsive gel carrier comprises from about 80.0% (w/w) to about 99.99% (w/w) of the composition.

11. The composition of claim 1, wherein the moisture sensitive polymer complex comprises carboxypolymethylene and polyvinylpyrrolidone.

12. The composition of claim 1, wherein the water soluble salt is selected from the group consisting of sodium saccharin, sodium chloride, potassium chloride, and ammonium chloride.

13. The composition of claim 2, wherein the temperature sensitive polymer comprises methylcellulose.

14. The composition of claim 2, wherein the temperature sensitive polymer comprises hydroxypropyl methylcellulose.

15. The composition of claim 2, wherein the temperature sensitive polymer comprises a poly(oxyethylene)-poly(oxypropylene) block copolymer.

16. The composition of claim 1, wherein the moisture sensitive polymer complex is present in an amount of about 0.01% (w/w) to about 50.0% (w/w) of the composition.

17. The composition of claim 1, wherein the moisture sensitive polymer is present in an amount of about 0.01% (w/w) to about 10.0% (w/w) of the composition.

18. A therapeutic dental delivery device for treating a condition in an oral cavity of a subject, comprising:
a liquid oral therapeutic dental composition;
an applicator for applying the composition to the oral cavity;
an activator; and
a reservoir located between the applicator and the activator and configured to store the composition,
wherein the activator is configured to dispense the composition from the reservoir to the applicator.

19. The device of claim 18, wherein the therapeutic dental composition comprises a moisture responsive gel carrier and a therapeutic agent dispersed in the moisture responsive gel carrier.

20. The device of claim 19, wherein the moisture responsive gel carrier comprises a moisture sensitive polymer complex and a water soluble salt.

21. The device of claim 18, wherein the applicator is selected from the group consisting of a brush, a felt tip, a roller ball, and a non-woven pad.

22. The device of claim 20, wherein the applicator is selected from the group consisting of a brush, a felt tip, a roller ball, and a non-woven pad.

23. The device of claim 18, wherein the activator is selected from the group consisting of a click mechanism, a twist and ratchet mechanism, and a push button.

24. The device of claim 20, wherein the activator is selected from the group consisting of a click mechanism, a twist and ratchet mechanism, and a push button.

25. The device of claim 18, wherein the applicator comprises a brush and the activator comprises a push button, wherein the push button dispenses the composition to the brush applicator.

26. The device of claim 18, wherein the applicator comprises a brush and the activator comprises a twist mechanism, wherein the twist mechanism dispenses the composition to the brush applicator.

27. The device of claim 18, wherein the applicator comprises a felt tip and the activator comprises a push button, wherein the push button dispenses the composition to the felt tip applicator.

28. The device of claim 18, wherein the applicator comprises a felt tip and the activator comprises a twist mechanism, wherein the twist mechanism dispenses the composition to the felt tip applicator.

29. The device of claim 20, wherein the applicator comprises a brush and the activator comprises a push button, wherein the push button dispenses the composition to the brush applicator.

30. The device of claim 20, wherein the applicator comprises a brush and the activator comprises a twist mechanism, wherein the twist mechanism dispenses the composition to the brush applicator.

31. The device of claim 20, wherein the applicator comprises a felt tip and the activator comprises a push button, wherein the push button dispenses the composition to the felt tip applicator.

32. The device of claim 20, wherein the applicator comprises a felt tip and the activator comprises a twist mechanism, wherein the twist mechanism dispenses the composition to the felt tip applicator.

33. The device of claim 20, wherein the moisture sensitive polymer complex comprises carboxypolymethylene and polyvinylpyrrolidone.

34. The device of claim 19, wherein the therapeutic agent comprises a peroxide.

35. The device of claim 19, wherein the therapeutic agent comprises hydrogen peroxide.

36. The device of claim 19, wherein the therapeutic agent comprises carbamide peroxide.

37. The device of claim 18, wherein the composition is present in an amount of from about 0.01 ml to 1.0 ml.

38. A therapeutic dental pen for treating a condition in an oral cavity of a subject, comprising:
a liquid oral therapeutic dental composition comprising a moisture responsive gel carrier and a therapeutic agent dispersed in the responsive gel carrier, wherein the gel carrier comprises a polymer complex including carboxypolymethylene and polyvinylpyrrolidone and a water soluble salt;
a brush-on applicator for applying the composition to the oral cavity;
a push button; and
a reservoir located between the applicator and the push button and configured to store the composition,
wherein the push button is configured to dispense the composition from the reservoir to the applicator.

39. The pen of claim 38, wherein the therapeutic agent comprises a peroxide.

40. The pen of claim 38, wherein the therapeutic agent comprises hydrogen peroxide.

41. The pen of claim 38, wherein the therapeutic agent comprises carbamide peroxide.

42. A dental therapeutic kit comprising:
a liquid oral therapeutic dental composition comprising a moisture responsive gel carrier and a therapeutic agent;
a delivery device comprising:
an applicator for applying the composition to the oral cavity;
an activator; and
a reservoir located between the applicator and the activator and configured to store the composition, wherein the activator is configured to dispense the composition from the reservoir to the applicator; and
a set of instructions.

43. A method for whitening teeth of a subject in need thereof, comprising:
providing a therapeutic dental composition comprising a moisture responsive gel carrier and a therapeutic agent dispersed in the responsive gel carrier, wherein the gel carrier comprises a polymer complex including carboxypolymethylene and polyvinylpyrrolidone and a water soluble salt; and
applying the composition to a tooth of the subject.

44. The method of claim 43, wherein the composition is applied to the tooth of the subject two times per day.

45. The method of claim 43, wherein the composition is applied to the tooth of the subject three times per day.

46. The method of claim 43, wherein the composition is applied to the tooth of the subject in intervals.

47. The method of claim 43, wherein the composition is applied to the tooth of the subject in fifteen minute intervals.

48. The method of claim 43, wherein the composition is applied to the tooth of the subject in 5 minute intervals.

49. The method of claim 43, wherein the composition is applied to the tooth of the subject in 15 minute intervals 2 times per day.

50. The method of claim 43, wherein the composition is applied to the tooth of the subject in 15 minute intervals 2 times per day.
